(19) United States
(12) Patent Application Publication
(10) Pub. No.: US 2025/0045260 A1
(43) Pub. Date: Feb. 6, 2025

(54) DATA ANALYSIS METHOD FOR HISTORICAL RELIGIOUS PROCESSION EVENTS AND GIS DISPLAY METHOD THEREOF

(71) Applicant: Rui-Zhe HOU, Taipei (TW)

(72) Inventor: Rui-Zhe HOU, Taipei (TW)

(21) Appl. No.: 18/365,642

(22) Filed: Aug. 4, 2023

(51) Int. Cl. G06F 16/22

(52) U.S. Cl. CPC G06F 16/22

(57) ABSTRACT

The present invention relates to a data analysis method for historical religious procession events and Geographic Information System (GIS) display method thereof, especially relates to a method for a “friendship analysis” and a “territory competition analysis” between two major temples based on the participation of procession events by the surrounding temples.

### BACKGROUND

### Technical Field

The invention relates to a data analysis method for historical religious procession events and Geographic Information System (GIS) display method thereof, especially focusing on the participation of surrounding temples in the main temple's procession events. The method involves analyzing “friendship connections” and “territory competition” between two main temples.

### Description of Related Art

Traditional religious procession events, such as Taiwan's Dajia Ma procession, the route maps of the procession are published on Google Maps for believers' reference. These route maps are all static displays and have no further interactive statistics and analysis functions.

### SUMMARY OF THE INVENTION

This invention provides a data analysis method for historical religious procession events and Geographic Information System (GIS) display method thereof. A database is created through the data entry of historical data into a computer system. Based on the participation of various temples (e.g., temples S, T, U), a “friendship analysis” and/or a “territory competition analysis” between two main temples (e.g., temples A, B) can be conducted. This information can be further displayed on a Geographic Information System (GIS) to provide users with visualized data for reference.

### BRIEF DESCRIPTION OF THE DRAWINGS

FIG. 1 shows a database created according to the present invention.

FIG. 2 shows a “friendship analysis” between two host temples (or religious units) according to the present invention.

FIG. 3 shows a “territory competition analysis” for two major temples (or religious units) according to the present invention.

### DETAILED DESCRIPTION OF THE INVENTION

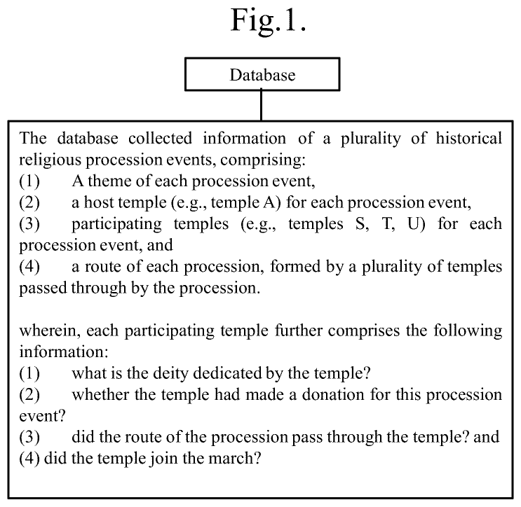

FIG. 1 shows a database created according to the present invention.

FIG. 1 shows the database collected the information of a plurality of religious procession events comprising:
(1) a theme of each procession event,
(2) a host temple (e.g., temple A) for each procession event,
(3) participating temples (e.g., temples S, T, U) for each procession event, and
(4) a route of each procession, formed by a plurality of temples passed through by the procession.
   wherein, each participating temple further comprises information including:
(1) what is the deity dedicated by the temple?
(2) whether the temple had made a donation for this procession event?
Check the box: □Yes, □No.
(3) did the route of the procession pass through the temple (or religious unit)?
Check the box: □Yes, □No., and
(4) did the temple (or religious unit) join the march?
Check the box: □Yes, □No.
   wherein the participating temple is qualified as a “sphere of influence” to the host temple if the participating temple meets one or more, depending on the user's choice, of the following information, selected from a group consisting of:
(1) for selected theme group, the participating temple is passed through by at least once in one of the routes;
(2) for selected theme group, the participating temple participated in all of the marches; and
(3) for selected theme group, the participating temple provided specific support to the host religious unit.

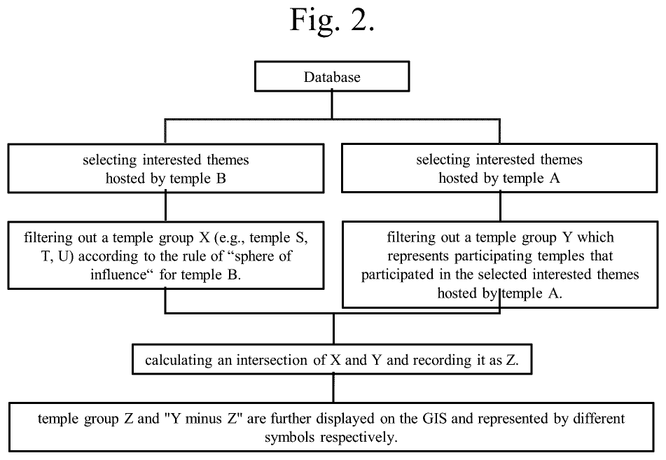

FIG. 2 shows a “friendship analysis” between two host temples (or religious units) according to the present invention.

The “friendship analysis” comprises the following steps:
(1) selecting interested themes hosted by temple B; and
(2) filtering out a temple group X (e.g., temple S, T, U) according to the rule of “sphere of influence” defined in the previous section for temple B.
   Wherein members of the temple group X are further displayed on the GIS with a specific mark. The specific mark can be different shapes, different colors, or different sizes to represent different meanings.
(3) selecting interested themes hosted by temple A; and
(4) filtering out a temple group Y which represents all participating temples that participated in the selected themes hosted by temple A.
   Wherein members of the temple group Y are further displayed on the GIS with a specific mark.
(5) calculating an intersection of X and Y and recording it as Z.
   Wherein members of the temple group Z are further displayed on the GIS with a specific mark.
   Wherein the size of the temple group Z represents the closeness of relationship between temple B and temple A. The bigger the temple group Z, the closer relationship between them, as participating temples under B's sphere of influence show support for temple A.
(6) The two temple groups Z and “Y minus Z” are further displayed on the GIS and represented by different symbols respectively.

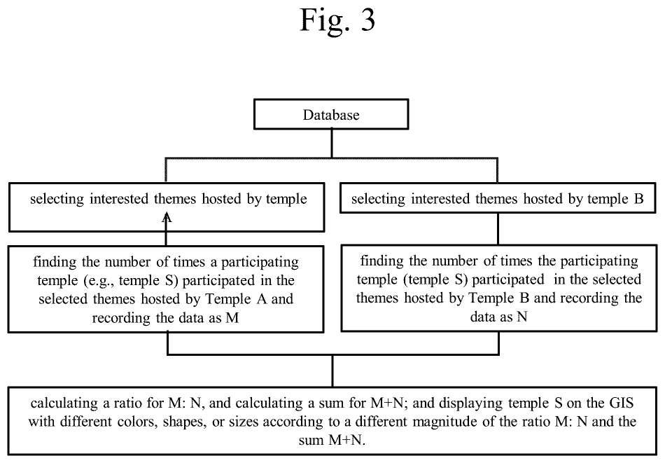

FIG. 3 shows a “territory competition analysis” for two major temples (or religious units) according to the present invention.

The “territory competition analysis” comprises the following steps:
(1) selecting interested themes hosted by temple A;
(2) finding a number of times a participating temple (e.g., temple S) participated in the selected themes hosted by Temple A and recording the data as M;
(3) selecting interested themes hosted by temple B;
(4) finding a number of times the participating temple S participated in the selected events hosted by Temple B and recording the data as N;
(5) calculating a ratio for M:N, and calculating a sum for M+N; and displaying the temple S on the GIS with different colors, shapes, or sizes according to a different magnitude of the ratio M:N and the sum M+N.

The GIS display method for religious processions according to the present invention, wherein the religion can be applied to other religious groups that hold procession activities participated by multiple places of worship, such as Taoism, Buddhism, Christianity, Islam, Hinduism, and Yiguandao.

Wherein, when the religion is Taoism, the religious unit is a temple.

Wherein, when the religion is Christianity, the religious unit is a church.

While several embodiments have been described by way of example, it will be apparent to those skilled in the art that various modifications can be made without departing from the spirit of the appended claims, which still belong to the right scope of the present invention.

What is claimed is:

1. A data analysis method for historical religious procession events and GIS display method thereof comprises creating a database that collects information comprising:
(1) a theme of each procession event,
(2) a host religious unit (e.g., temple A) for each procession event,
(3) participating religious units (e.g., temples S, T, U) for each procession event, and
(4) a route of each procession, formed by a plurality of religious units passed through by the procession.

2. The method as claimed in claim 1, wherein, each participating religious unit further comprises one or more of the following information:
(1) what is the deity dedicated by the religious unit?
(2) whether the religious unit had made a donation for this procession event?
(3) did the route of the procession pass through the religious unit? and
(4) did the religious unit join the march?

3. The method as claimed in claim 2, wherein the host religious unit further comprises one or more information selected from a group consisting of: latitude and longitude, address, and deity to which the religious unit is dedicated.

4. The method as claimed in claim 1, wherein the participating religious unit is qualified as a “sphere of influence” to the host religious unit if the participating religious unit meets one or more of the following information selected from a group consisting of:
(1) for selected theme group, the participating religious unit is passed through by at least once in one of the routes.
(2) for selected theme group, the participating religious unit participated in all of the marches.
(3) for selected theme group, the participating religious unit provided specific support to the host religious unit.

5. The method as claimed in claim 4, further comprises:
(1) selecting interested themes hosted by religious unit B; and
(2) filtering out a unit group X (e.g., temple S, T, U) according to the rule of “sphere of influence”; wherein X shows a “sphere of influence” of religious unit B.

6. The method as claimed in claim 5, wherein members of the unit group X are further displayed on the GIS with a specific mark.

7. The method as claimed in claim 6, wherein the specific mark is one of different shapes, different colors, or different sizes to represent different meanings.

8. The method as claimed in claim 5, further comprises:
(1) selecting interested themes hosted by religious unit A; and
(2) filtering out a unit group Y which represents all participating religious units that participated in the selected themes hosted by religious unit A.

9. The method as claimed in claim 8, wherein members of the unit group Y are further displayed on the GIS with a specific mark.

10. The method as claimed in claim 9, further comprises: calculating an intersection of unit group X and unit group Y, and recording it as unit group Z.

11. The method as claimed in claim 10, wherein members of the unit group Z and unit group Y minus unit group Z are further displayed on the GIS, and represented by different symbols respectively.

12. The method as claimed in claim 1, further comprises:
(1) selecting interested themes hosted by religious unit A; and
(2) finding participating times and recording it as M for a participating religious unit (e.g., temple S) that participated in the selected themes.

13. The method as claimed in claim 12, further comprises:
(1) selecting interested themes hosted by religious unit B; and
(2) finding participating times and recording it as N for the participating religious unit (temple S) that participated in the selected themes hosted by religious unit B.

14. The method as claimed in claim 13, further comprises:
calculating a ratio for M:N.

15. The method as claimed in claim 14, further comprises:
displaying the religious unit on the GIS with different colors, shapes, or sizes according to a different magnitude of the ratio M:N.

16. The method as claimed in claim 13, further comprises: calculating a sum for M+N.

17. The method as claimed in claim 16, further comprises:
displaying the religious unit on the GIS with different colors, shapes, or sizes according to a different magnitude of the sum M+N.

18. The method as claimed in claim 1, wherein
the religious procession is associated with a religion selected from a group consisting of: Taoism, Buddhism, Christianity, Islam, Hinduism, and Yiguandao.

19. The method as claimed in claim 18, wherein
when the religion refers to Taoism, the religious unit refers to a temple.

20. The method as claimed in claim 18, wherein
when the religion refers to Christianity, the religious unit refers to a church.
